(19) United States
(12) Patent Application Publication
(10) Pub. No.: US 2017/0068950 A1
(43) Pub. Date: Mar. 9, 2017

(54) ON-LINE CREDIT CARD PAYMENT SYSTEM USING MOBILE TERMINAL AND PAYMENT METHOD THEREOF

(71) Applicant: NHN Entertainment Corporation, Seongnam-si (KR)

(72) Inventor: Eun Jin KWON, Seongnam-si (KR)

(21) Appl. No.: 14/980,814

(22) Filed: Dec. 28, 2015

(30) Foreign Application Priority Data
Sep. 3, 2015 (KR) 10-2015-0124757

(51) Int. Cl. G06Q 20/34; G06Q 20/12; G06Q 20/38; G06Q 20/24

(52) U.S. Cl. CPC G06Q 20/353; G06Q 20/24; G06Q 20/12; G06Q 20/385

(57) ABSTRACT

An on-line credit card payment includes a user terminal to access a shopping mall server and select at least one commodity information transmitted by the shopping mall server and request payment based on the selected commodity information; a payment server configured to receive a payment signal according to the payment request from the shopping mall server, and generate a push message corresponding to the payment signal; a mobile terminal configured to receive the push message and including a payment application which automatically operates in response to receipt of the push message; a value added network (VAN) company server configured to transmit a one-time card number (OTC) from the mobile terminal to the payment server, and extract a card number by receiving a block data of a credit card corresponding to the OTC from the payment server; and a card company server configured to approve the credit card payment.

### CROSS-REFERENCE TO RELATED APPLICATION

This application claims priority from and the benefit of Korean Patent Application No. 10-2015-0124757, filed on Sep. 3, 2015, which is hereby incorporated by reference for all purposes as if fully set forth herein.

### BACKGROUND

Field

Exemplary embodiments relate to credit card payment system. More particularly, exemplary embodiments relate to on-line credit card payment system using mobile terminal and payment method thereof.

Discussion of the Background

With the steady growth of an electronic commerce on the internet, online payment marketplace is also expanding rapidly. Moreover, while many methods of payment on the internet are made via credit cards and on-line payments, new methods of payment using mobile terminals or wired and wireless automatic response services (ARSs) have recently emerged and their frequency of use is increasing at a rapid pace.

However, in the case of these methods of payment, providing a separate module or mobile card may cause inconvenience, and there may be a danger of leakage of personal information. Regarding credit card payment on the internet, for example, which users could enter the credit card information directly on the internet may also create inconvenience or security concerns.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a system and a method related to on-line credit card payment using a mobile terminal.

Additional aspects will be set forth in the detailed description which follows, and, in part, will be apparent from the disclosure, or may be learned by practice of the inventive concept.

An exemplary embodiment discloses an on-line credit card payment system using mobile terminal that includes a user terminal configured to access a shopping mall server and select at least one among commodity information transmitted by the shopping mall server, and request payment based on the selected commodity information; a payment server configured to receive a payment signal according to the payment request from the shopping mall server, and generate a push message corresponding to the payment signal; a mobile terminal configured to receive the push message, the mobile terminal including a payment application which automatically operates in response to receipt of the push message; a value added network (VAN) company server configured to transmit an one-time card number (OTC) which is received from the mobile terminal to the payment server, and extract a card number by receiving a block data of credit card corresponding to the OTC from the payment server; and a card company server configured to approve the credit card payment by receiving the card number and information included in the payment signal from the VAN company server.

Another exemplary embodiment discloses a payment method using mobile terminal that includes selecting at least one among commodity information transmitted by a shopping mall server which is accessed by a user terminal, and requesting payment corresponding to the selected commodity information, receiving a payment signal corresponding to the payment request from the shopping mall server, and generating a push message corresponding to the payment signal, receiving the push message and operating a payment application automatically in response to receipt of the push message, extracting information of the credit card in response to tagging a credit card to a mobile terminal, extracting a card number through an one-time card number (OTC) of the credit card transmitted from the mobile terminal, and approving credit card payment corresponding to the payment request by using the card number and information included in the payment signal.

Another exemplary embodiment discloses a payment method using mobile terminal that includes selecting at least one among commodity information transmitted by a shopping mall server which is accessed by a user terminal, and requesting payment corresponding to the selected commodity information, receiving a payment signal corresponding to the payment request from the shopping mall server, and generating a push message by a payment server corresponding to the payment signal, tagging the mobile terminal to a credit card storing a block data including a chip ID and a first block data, transmitting the block data to the payment server by receiving the block data of the credit card in response to the tagging and requesting assignment of a one-time card number (OTC) to the payment server, requesting payment to the value added network (VAN) company server by adding a purchase item to the OTC, requesting the block data to the payment server by using the OTC, and extracting a card number of the credit card from the block data, requesting approval of payment by transmitting the card number and the purchase item to a card company server.

Another exemplary embodiment discloses mobile terminal includes a near field communication (NFC) module configured to extract an identification information of a credit card by tagging the credit card to the mobile terminal, an application driver configured to drive the payment application in response to receiving to the push message from the payment server, and an authentication information processor configured to receive and process the authentication information of the credit card by tagging the credit card, wherein an NFC tagging screen used to tag the credit card is displayed in response to operation of the payment application.

Another exemplary embodiment discloses payment server includes a push message transmitter configured to generate the push message and transmit the push message to the mobile terminal, an authentication signal generator configured to generate an access key corresponding to block data of a credit card having a first chip ID and a one-time card number (OTC) of the credit card, and transmit the OTC to the mobile terminal, and a validation verifier configured to verify validation of the credit card in response to requesting transmitting of the OTC and the block data transferred from the mobile terminal, and order the authentication signal generator to generate the OTC in response to the result of the validation.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram of an on-line credit card payment system according to an exemplary embodiment.

FIG. 2 is a view illustrating a display screen of a mobile terminal according to an exemplary embodiment.

FIG. 3 is a block diagram illustrating a structure of a payment server according to an exemplary embodiment.

FIG. 4 is a block diagram illustrating a structure of a mobile terminal according to an exemplary embodiment.

FIG. 5 is a flow chart illustrating an on-line credit card payment method according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

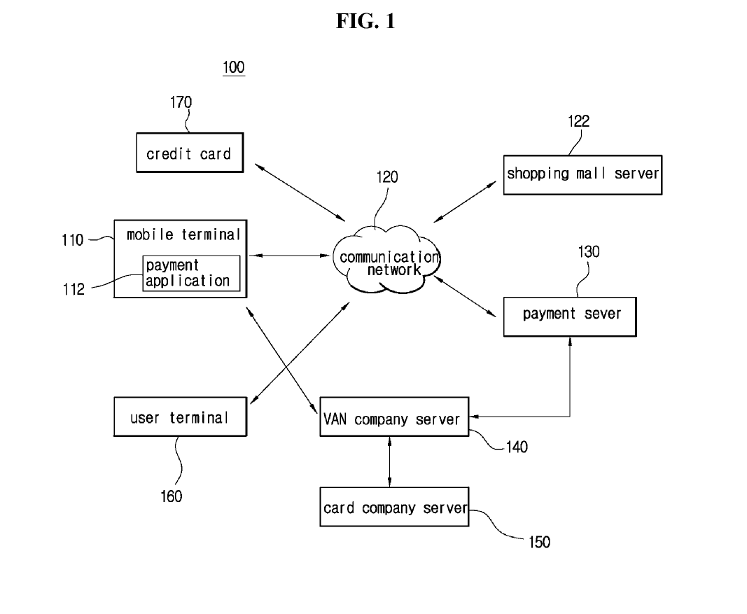

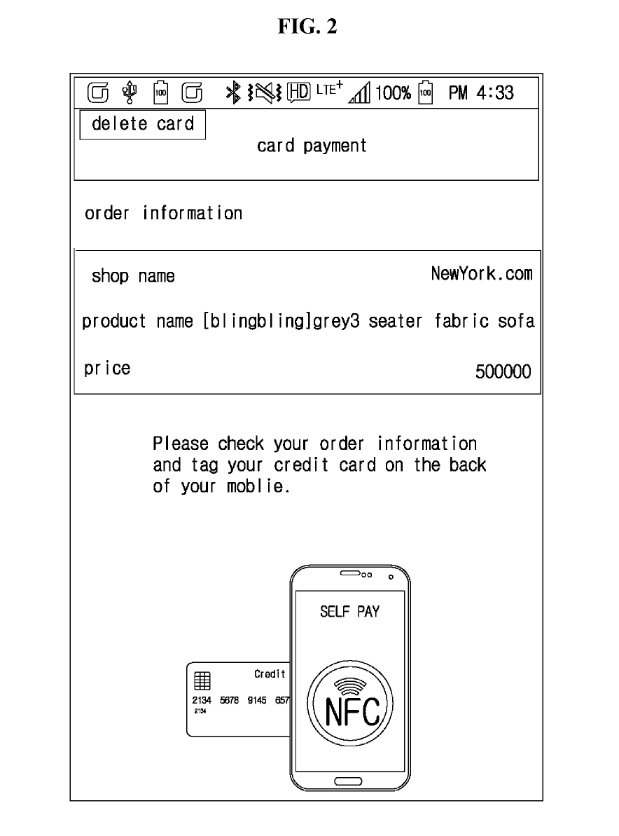

FIG. 1 is a block diagram of an on-line credit card payment system according to an exemplary embodiment, and FIG. 2 is a view illustrating a display screen of a mobile terminal according to an exemplary embodiment.

Referring to FIG. 1, an on-line credit card payment system 100 according to an exemplary embodiment comprises a mobile terminal 110 in which payment application 112 is installed, communication network 120, shopping mall server 122, payment server 130, valued added network (VAN) company server 140, and card company server 150. In addition, when users access the shopping mall server 122, the users may use not only their mobile terminal 110 but also a separate user terminal 160.

The components as illustrated in FIG. 1 are merely illustrative of this exemplary embodiment, and many alterations and modifications may be made to the components included in the on-line credit card payment system.

The mobile terminal 110 refers to a terminal that can transmit and receive various data via communication network 120 depending on a user's key manipulation and may be, for example, any one of a tablet PC, a smart phone, a personal digital assistant (PDA), and a mobile communication terminal.

The mobile terminal 110 may include a near field communication (NFC) module, and may execute payment with the credit card 170 via radio frequency (RF) communication. For example, the mobile terminal 110 may read the information of the credit card 170 by an RF communication such as tagging, playing a role as a credit card payment terminal.

The credit card 170 may include memory storing information such as a card number and a chip ID (CI), and it may transmit the information stored in the memory to the mobile terminal 110 via RF communication. The card number and CI stored in the credit card 170 may be stored to a plurality of block data. The card number and CI may be transmitted as a request from the mobile terminal 110 generated by the short distance RF communication such as tagging. The CI may include a first CI that is readable by the mobile terminal without a separate access key and a second CI that requires an access key and requires decoding because the block data is encoded as a first block data.

However, the mobile terminal 110 may request the access key to the payment server 130 in order to access the encoded block data stored in the credit card 170, and only the mobile terminal 110 to which the access key was provided from the payment server 130 can acquire the encoded block data.

The payment application 112 is installed in the mobile terminal 110 in advance, and may automatically operate according to the push massage that is transmitted to the mobile terminal 110 from the payment server 130. Thereafter, the payment application 112 may display the NFC tagging screen on the mobile terminal 110. For example, the payment application 112 may automatically set up the NFC tagging screen as an initial screen of the mobile terminal 110.

FIG. 2 is a view illustrating a display screen of a mobile terminal according to an exemplary embodiment.

When the payment application 112 operates automatically and the NFC tagging screen is displayed, the mobile terminal 110 acts as a payment terminal. For example, when the NFC module in the mobile terminal 110 is activated and the credit card 170 is tagged to the mobile terminal 110 which displays the NFC tagging screen, payment process may be executed.

When the credit card 170 is tagged to the mobile terminal 110, the mobile terminal 110 initially transmits the first CI and requests the access key to the payment server 130, then receives the access key from the payment server 130 and reads the block data of the credit card 170. In addition, the mobile terminal 110 may request a one-time card number (OTC) for the block data to the payment server 130. When the OTC is provided in response to a request from the mobile terminal 110, the mobile terminal may transmit the payment request information with the OTC to the VAN company server 140, and may request payment.

The payment application 112 may be, for example, an application downloaded and installed from an application store, when the mobile terminal 110 is a smart phone.

The payment application 112 installed in the mobile terminal 110 may be requested a membership registration process. For example, the membership registration process may include a step of requesting at least one of user identification information, authentication information, and terminal personal identification number (PIN) authentication information by the payment server 130.

Accordingly, when the payment application 112 is authenticated, the payment server 130 receives an ID of the payment application 112 to execute on-line credit card payment and completes the membership registration process through registered user's credit card 170 information as a method of payment information.

For example, for the registration of the credit card information as a method of payment information, the mobile terminal 110 may transmit the user's credit card information to the payment server 130. The mobile terminal 110 may also transmit the method of payment authentication information including, for example, at least one of a card company identification information, card number information, card expiration date information, virtual card number information, and CVC information to the payment server 130.

The user of the payment application 112 and the user of the credit card 170 may be the same. This may be identified by conducting an authenticating procedure in the membership registration process and credit card information registration process.

The user terminal 160 is a device separate from the mobile terminal 110 and is a terminal that may transmit and receive various data via the communication network 120 depending on the user's key manipulation and may be, for example, any one of a tablet PC, a laptop, a personal computer, etc. Moreover, the user terminal 160 is a terminal equipped with, for example, a web browser for communication with the shopping mall server 122 in conjunction with the communication network 120, a memory for storing programs, a microprocessor for calculation and control when executing the programs, etc.

While the user terminal 160 may be a personal computer, any terminal is available as long as it is connected to the communication network 120 and provides server-client communication with the shopping mall server 122. The user terminal 160 may encompasses all communication computing devices, for example, such as a notebook computer, a mobile communication terminal, a PDA, etc. After accessing the shopping mall server 122 in response to the user's manipulation and command, the user terminal 160 may receive various commodity information from the shopping mall server 122 and may display the received information.

In FIG. 1, the user terminal 160 and the mobile terminal 110 are illustrated as separate terminals, but this is only an exemplary embodiment and the user terminal 160 may be same as the mobile terminal 110.

The user may log into the shopping mall server 122 with his or her user account (ID and password) using the user terminal 160 and request payment for a specific commodity from the commodity information provided by the shopping mall server 122 when the user wants to purchase a specific commodity. The payment request may be performed by selecting the method of payment corresponding to the NFC tagging.

Then a payment signal corresponding to the payment request may be transmitted to the payment server 130. The payment signal may include payment request information, methods of payment information of the user, and purchase item information, etc.

The payment server 130 may then transmit the push message corresponding to the payment signal to the mobile terminal 110 and the payment application 112 installed in the mobile terminal 110 may automatically operate according to the push message.

Also, the payment application 112 which operates automatically may load a screen for credit card tagging, such as an NFC tagging screen, on the mobile terminal 110 immediately.

As illustrated in FIG. 2, the NFC tagging screen may show information of commodity that the user wants to purchase. The order information may also include information of the shopping mall server 122 and the name and price information of the goods to purchase.

When the NFC tagging screen is displayed on the mobile terminal 110 after operation by the payment application 112, the mobile terminal 110 acts as a payment terminal by tagging the credit card 170 to the mobile terminal 110. That is, on-line credit card payment can be executed through the mobile terminal 110.

After completing credit card payment, the user terminal 160 may receive information of payment completion and display the screen corresponding thereto.

The communication network 120 is a network that can transmit and receive data via the internet protocol using various wired and wireless communication technologies such as the internet network, intranet network, mobile communication network, satellite communication network, etc. Moreover, the communication network 120 may comprise a cloud computing network which is connected to the payment server 130 to store computing resources such as hardware, software, etc. and provide the computing resources required by a client to the mobile terminal 110. Here, the cloud computing refers to a computing environment where information is permanently stored in a server on the internet and temporarily stored in a client terminal such as a desktop, tablet, notebook, netbook, smart phone, etc., and the cloud computing network where all users' information is stored in a server on the internet such that the information can be used anywhere and anytime through various IT services.

The communication network 120 may be, for example, closed networks such as a local area network, wide area network (WAN), etc., open networks such as code division multiple access (CDMA), wideband code division multiple access (WCDMA), global system for mobile communication (GSM), long term evolution (LTE), evolved packet core (EPC), etc., next-generation networks which will be implemented in the future, and cloud computing networks.

When the user terminal 160 has accessed the shopping mall server 122, the shopping mall server 122 transmits commodity information to the user terminal 160 through the communication network 120, and when a payment signal for specific commodity information is received from the user terminal 160 transmits the payment signal to the payment server 130.

The shopping mall server 122 may transmit commodity information to the accessed user terminal 160, and when a payment request for specific commodity information among the commodity information is received from the user terminal 160, may transmit payment request information for the user account information of the user terminal 160. For example, after accessing the shopping mall server 122 through the user terminal 160, the user may log into the shopping mall server 122 using his or her user account (ID and password) and may select payment request information from the commodity information provided by the shopping mall server 122 when the user wants to purchase a specific commodity. The shopping mall server 122 may include at least one of a web providing device for providing specific commodity information and a payment gateway (PG) for linking to the payment server 130 in response to the payment request information.

The payment server 130 may have the same configuration as a typical web server or network server. However, in a software configuration, the payment server 130 includes a program module implemented using languages such as C, C++, Java, Visual Basic, Visual C, etc. and the payment server 130 may be implemented in the form of a web server or network server. The web server refers to a computer system, which is connected to an unspecified number of clients and/or other servers through an open computer network such as the internet, receives an operation execution request from a client or another web server, and provides the corresponding operation result, and a computer software (web server program) installed for the same. However, it should be understood that the payment server 130 may encompass a series of application programs executed on the web server and various databases built therein according to circumstances, in addition to the above mentioned web server program.

The payment server 130 may be implemented on a typical server hardware using various web server programs provided for various operating systems such as DOS, Windows, Linux, UNIX, Macintosh, etc. Representative examples thereof may include Website, Internet Information Server (IIS), etc. used in Window environment and CERN, NCSA, APPACH, etc. used in UNIX environment.

Moreover, the payment server 130 may be connected to an authentication system for member registration and a payment system. Furthermore, the payment server 130 classifies member subscription information and stores and manages the information in a member database, which may be implemented inside or outside the payment server 130. Such database may be a data structure implemented in as storage space (e.g., a hard disk or memory) of a computer system using a database management system (DBMS), in which retrieval (extraction), deletion, edition, addition, etc. of data can be freely performed. The database may be implemented to achieve the purpose of an exemplary embodiment using a relational database management system (RDBMS) such as, for example, Oracle, Infomix, Sybase, DB2, etc., an object-oriented database management system (OODBMS) such as Gemstone, Orion, O2, etc. or an XML native database such as Excelon, Tamino, Sekaiji, etc., and has appropriate fields or elements to achieve its functions.

The payment server 130 may provide an on-line credit card payment service with the payment application 112 installed in the mobile terminal 110.

Specifically, the payment server 130 may receive the payment signal according to information of a specific commodity from the shopping mall server 122. Thereafter, the payment server 130 may transmit the push message responding to the payment signal to the mobile terminal 110, and the payment application 112 installed in the mobile terminal 110 may operate automatically according to the push message and display the NFC tagging screen on the mobile terminal 110 by the operation of the payment application 112.

When the user's credit card 170 is tagged to the mobile terminal 110 that displays the NFC tagging screen by operation of the payment application 112, the mobile terminal 110 acts as a payment terminal.

When the payment server 130 transmits the push message to the payment application 112 of the mobile terminal 110 and the payment application 112 operates automatically according to the push message, on-line credit card payment may be executed by connecting the mobile terminal 110 with the card company server 150 and the VAN company server 140.

For example, when the payment server 130 receives a request to send an access key with a first CI from the mobile terminal 110, the payment server 130 transmits the access key that can access the block data of the credit card having the first CI to the mobile terminal 110. In addition, the payment server 130 receives the block data from the mobile terminal 110. At this time, when the mobile terminal 110 sends the block data to the payment server 130, the mobile terminal 110 may request the OTC to the payment server 130. After that, the payment server 130 may verify the validness of the credit card, and issue the OTC according to the result of the verification. More specifically, the payment server 130 may receive the block data and request of the OTC from the mobile terminal 110, extract a second CI from a first block data of the block data, and compare the second CI with the first CI. If the second CI and the first CI are identical, the payment server 130 determines the credit card is valid, creates the OTC, and sends the OTC to the mobile terminal 110.

At this time, the payment server 130 may make the OTC correspond to the first CI, and may store the OTC. Furthermore, when the OTC is transferred from the VAN company server 140, the payment server 130 may check on the first CI which corresponds to the OTC and transmit the block data of the credit card 170 having the first CI to the VAN company server 140. The block data transferred from the payment server 130 to the VAN company server 140 is the block data transferred from the mobile terminal 110 when the OTC is requested, and it may be deleted in the payment server 130 simultaneously when being transferred to the VAN company server 140.

Meanwhile, a membership registration process may be preceded before the payment process by the payment server 130, and this membership registration process may be similar and coupled with the membership registration process of the payment application 112 above mentioned.

The payment server 130 according to an exemplary embodiment may transmit the push message to the mobile terminal 110 in order to drive the payment applications 112 installed in the mobile terminal 110.

Hereinafter, transmitting process of the push message will be described in detail.

A user may log into the shopping mall server 122 with the user's account (ID and password) using the user terminal 160 and request payment for a specific commodity from the commodity information provided by the shopping mall server 122 when the user wants to purchase the specific commodity.

Then a payment signal corresponding to the payment request may be transmitted to the payment server 130. The payment signal may include payment request information, methods of payment information of the user, and purchase item information, etc.

The payment server 130 may then transmit the push message corresponding to the payment signal to the mobile terminal 110 and the payment application 112 installed in the mobile terminal 110 automatically operates according to the push message.

The payment application 112 which operates automatically may also display the NFC tagging screen on the mobile terminal 110, and the NFC tagging screen may show information of commodity that the user wants to purchase. For example, the information of the commodity to purchase may include information of the shopping mall server 122 and a name and price information of the goods to purchase.

The VAN company server 140 may be connected with the payment server 130 and the card company server 150 through VAN, and relay the request information for an electronic payment and transmit/receive data.

In addition, the VAN company server 140 may receive payment request for the purchase items, and may execute the payment process. The purchase items may include, for example, commodity, place, time/date to pay, etc.

The VAN company server 140 may transfer the OTC which was transferred from the mobile terminal 110 to the payment server 130 and may request the block data corresponding to the OTC. Furthermore, when the VAN company server 140 receives the block data from the payment server 130, the VAN company server 140 may extract the real card number included in the block data through decoding the block data by a predetermined decoding algorithm or a decoding module.

Furthermore, the VAN company server 140 may request the payment by sending the real card number and purchase items to the card company server 150 through the communication line which has no outside exposure. When the payment approval is completed by the VAN company server 140 and the card company server 150, it may be transmitted to the mobile terminal 110 where the payment is executed.

The VAN company provides apparatus or networks to off-line credit card member stores in order to pay by using, for example, a credit card terminal, and charges the service fee. The VAN company may include PG (Payment Gateway) performing the role on-line.

The card company server 150 is a server that can make an electronic payment. The card company server 150 may pay the cost according to the payment request signal for the registered credit card, and may authorize the information related to the credit card.

The card company server 150 may confirm the card number and the purchase items, and approve the payment according to the request payment transferred from the VAN company server 140, and transfer the approval result to the VAN company server 140.

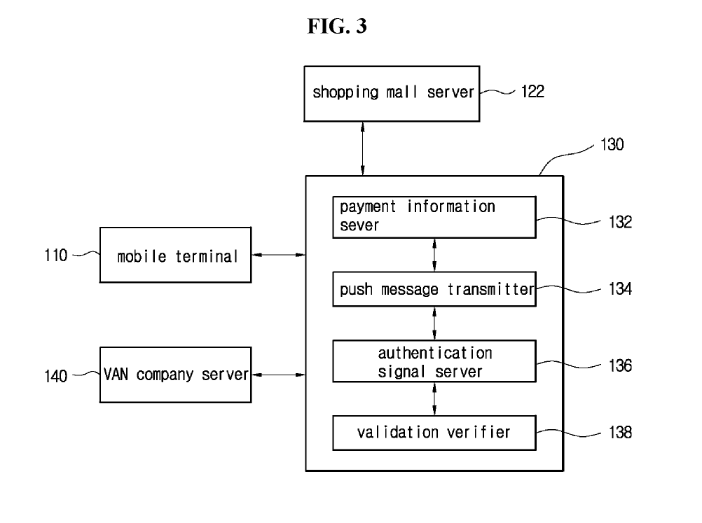

FIG. 3 is a block diagram illustrating a structure of a payment server according to an exemplary embodiment.

Referring to FIG. 3, the payment server 130 may include a payment information receiver 132, a push message transmitter 134, an authentication signal generator 136, and a validation verifier 138.

The payment information receiver 132 may receive the payment signal related to the user account information from the shopping mall server 122. That is, the payment information receiver 132 may receive the user account information and the payment request information, etc. from the shopping mall server 122 when the user logs into the shopping mall server 122 with his or her user account (ID and password) using the user terminal 160.

However, the above process is based on a premise that 1) a user accesses the shopping mall server 122 through the user terminal 160, 2) the user logs into the shopping mall server 122 using the user's account (ID and password), and 3) the user selects payment request information from the commodity information provided by the shopping mall server 122 when the user wants to purchase a specific commodity.

The push message transmitter 134 may transmit the push message to the mobile terminal 110 in order to drive the payment applications 112 installed in the mobile terminal 110.

When the payment application 112 receives the push message from the payment server 130, the payment application 112 automatically operates and displays the NFC tagging screen on the mobile terminal 110. When the credit card 170 is tagged to the mobile terminal 110 displaying the NFC tagging screen, the mobile terminal 110 may act as a payment terminal.

For example, when the mobile terminal 110 receives the first chip ID of the credit card 170 from the credit card 170 being tagged to the mobile terminal 110, the mobile terminal 110 may request sending an access key in response to transmitting the first chip ID to the payment server 130.

The authentication signal generator 136 may transmit the access key which is able to access the block data of the credit card 170 having the first chip ID. In addition, the authentication signal generator 136 may generate the OTC according to an order of the validation verifier 138, and may send the OTC to the mobile terminal 110.

The validation verifier 138 may verify validation of the credit card 170 in response to requesting sending OTC and the block data transferred from the mobile terminal, and transfer an order of whether to generate the OTC to the authentication signal generator 136 according to result of the validation.

More specifically, the validation verifier 138 may extract the second chip ID from the first block data of the block data, and compare the second chip ID with the first chip ID. When the second chip ID is same as the first chip ID, the validation verifier 138 determines the credit card 170 is valid and orders the authentication signal generator 136 to generate OTC.

At this time, the authentication signal generator 136 may store the OTC corresponding to the first chip ID. When the OTC is transferred from the VAN company server 140, the authentication signal generator 136 may confirm the first chip ID which corresponds to the generated OTC, and transmit the block data of the credit card 170 having the first chip ID to the VAN company server 140.

However, the block data transmitted to the VAN company server 140 may be the block data transferred from the mobile terminal 110 while the OTC is requested. The block data may be deleted in the authentication signal generator 136 and transmitted to the VAN company server 140 at the same time.

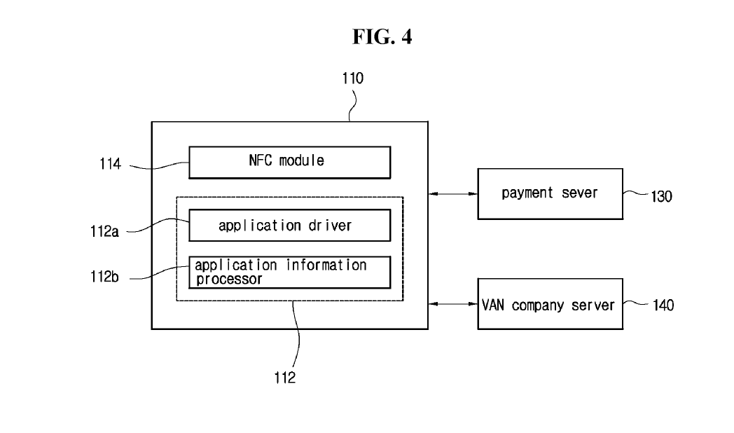

FIG. 4 is a block diagram illustrating a structure of a mobile terminal according to an exemplary embodiment.

Referring to FIG. 4, the mobile terminal 110 may include a NFC module 114, an application driver 112a, and an authentication information processor 112b. The application driver 112a and the authentication information processor 112b illustrated in FIG. 4 may be implemented as the payment application 112 shown in FIG. 1.

The NFC module 114 may extract credit card identification information in the credit card 170 in response to the credit card 170 being located within a predetermined distance from the NFC module 114 or being in contact with the NFC module 114. The credit card identification information may include, for example, an identification number, a security number, a valid period, and a CVV number. However, this is merely one embodiment, and the present invention is not necessarily limited thereto.

The application driver 112a may drive the payment application according to the push message from the payment server 130. When the application driver 112a receives the push message, it may invoke the payment application 112 installed in the mobile terminal 110.

In addition, when the payment application 112 is operated by the application driver 112a, the mobile terminal immediately displays the NFC tagging screen (refer to FIG. 2).

After the NFC module 114 is activated and the payment application 112 is operated, the authentication information processor 112b may request the access key by transmitting the first chip ID of the credit card 170 which is received by tagging a credit card to the mobile terminal 110.

Furthermore, when the authentication information processor 112b receives the access key from the payment server 130, the authentication information processor 112b may extract block data of the credit card 170 and transfer the block data to the payment server 130. The authentication information processor 112b may request the OTC from the payment server 130 as well as transfer the block data to the payment server 130. When the authentication information processor 112b receives the OTC, the authentication information processor 112b transfers the payment request information as well as the OTC to the VAN company server 140.

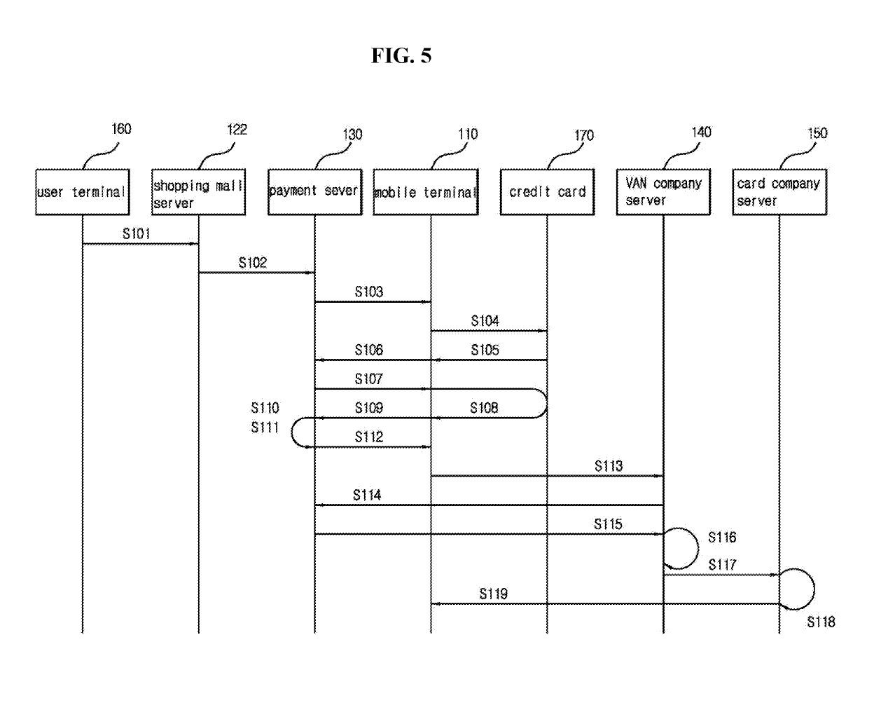

FIG. 5 is a flow chart illustrating an on-line credit card payment method according to an exemplary embodiment.

Referring to FIG. 5, the user may log into the shopping mall server 122 with the user's account (ID and password) using the user terminal 160 and request payment for a specific commodity from the commodity information provided by the shopping mall server 122 when the user wants to purchase the specific commodity (S101).

Then a payment signal corresponding to the payment request may be transmitted to the payment server 130 (S102). The payment signal may include payment request information, methods of payment information of the user, and purchase item information, etc.

The payment server 130 may transmit the push message corresponding to the payment signal to the mobile terminal 110 and the payment application 112 installed in the mobile terminal 110 automatically operates according to the push message. Also, the payment application 112 which operates automatically loads a screen that can be used for tagging the credit card, that is, the NFC tagging screen, on the mobile terminal 110 immediately (S103).

As illustrated in FIG. 2, the NFC tagging screen may show information of commodity that the user wants to purchase. For example, the information of the purchase commodity may include information of the shopping mall server 122 and a name and price information if the goods to purchase.

When the NFC tagging screen is displayed on the mobile terminal 110 after operation of the payment application 112, the mobile terminal 110 may act as a payment terminal. That is, when the NFC module 114 of the mobile terminal 110 is activated, on-line credit card payment can be executed through tagging credit card 170 to the mobile terminal 110 which displays the NFC tagging screen.

After tagging credit card 170 to the mobile terminal 110, the mobile terminal 110 may extract a chip ID from the credit card 170 while tagging (S104, S105). The chip ID is an ID of the chip mounted in the card and a characteristic identifier given from the card company.

Then the mobile terminal 110 may transfer the chip ID extracted from the credit card 170, and requests an access key corresponding to the chip ID to the payment server 130.

The payment server 130 which receives the chip ID and a request for the access key transfers the access key corresponding to the chip ID to the mobile terminal 110 (S107).

The mobile terminal 110 may read the block data stored in the credit card 170 by using the access key received form the payment server 130, and may transfers the block data which is in an encoded state to the payment server (S108, S109). When the mobile terminal 110 sends the block data to the payment server 130, the mobile terminal 110 may also request the OTC to the payment server 130.

The payment server 130 may analyze the first block data of the block data transferred from the mobile terminal 110, and may confirm the information in the first block data, the encoded chip ID. The payment server 130 may then verify validation of the credit card 170 through determining whether the second chip ID extracted from the first chip ID and the first chip ID transferred when requesting the access key are identical (S110).

More specifically, the payment server 130 compares with the second chip ID and the first chip ID. When the second chip ID is same as the first chip ID, the payment server 130 determines the credit card 170 is valid and may generate OTC corresponding to the first chip ID (S111), and transfers the OTC to the mobile terminal 110.

The mobile terminal 110 may request payment to the VAN company server 140 by adding payment information such as purchase item etc. to the OTC (S113).

The VAN company server 140 may transfer the OTC transferred from the mobile terminal 110 to the payment server 130 and may request the block data of the credit card 170 corresponding to the OTC (S114).

Furthermore, the payment server 130 may provide the block data to the VAN company server 140 as the request from the VAN company server 140, and then the VAN company server 140 may extract the actual card number included in the block data by analyzing the block data (S116).

When the card number is extracted, the VAN company server 140 transfers the card number which is extracted and the payment information to the card company server 150, and requests payment at the same time (S117).

The card company server 150 may approve the payment with confirming the payment information and card number (S118), and the result of the approval payment may be transferred to the mobile terminal 110 through the VAN company server 140 (S119).

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An on-line credit card payment system using a mobile terminal comprising:
a user terminal configured to access a shopping mall server and select at least one commodity information transmitted by the shopping mall server, and request payment based on the selected commodity information;
a payment server configured to receive a payment signal according to the payment request from the shopping mall server, and generate a push message corresponding to the payment signal;
the mobile terminal configured to receive the push message, the mobile terminal comprising a payment application which automatically operates in response to receipt of the push message;
a value added network (VAN) company server configured to transmit a one-time card number (OTC) from the mobile terminal to the payment server, and extract a card number by receiving a block data of a credit card corresponding to the OTC from the payment server; and
a card company server configured to approve the credit card payment by receiving the card number and information in the payment signal from the VAN company server.

2. The on-line credit card payment system of claim 1, wherein the mobile terminal comprises:
a NFC module configured to extract an identification information from the credit card in response to the credit card being tagged to the mobile terminal;
an application driver configured to drive the payment application in response to receiving the push message from the payment server; and
an authentication information processor configured to request an access key for the credit card by transmitting a first chip ID of the credit card received by tagging the credit card.

3. The on-line credit card payment system of claim 2, wherein the authentication information processor extracts block data of the credit card, and transfers the block data and requests the OTC to the payment server, the authentication information processor transferring payment request information and the OTC received from the payment server to the VAN company server.

4. The on-line credit card payment system of claim 1, wherein the payment server comprises:
a payment information receiver configured to receive the payment signal from the shopping server;
a push message transmitter configured to generate the push message and transmit the push message to the mobile terminal;
an authentication signal generator configured to generate an access key corresponding to the block data of the credit card having a first chip ID and the OTC of the credit card, and transmit the OTC to the mobile terminal; and
a validation verifier configured to verify validation of the credit card with a validation result in response to requesting transmitting the OTC and the block data transferred from the mobile terminal, and order the authentication signal generator to generate the OTC in response to the validation result.

5. The on-line credit card payment system of claim 4, wherein the validation verifier extracts a second chip ID from a first block data of the block data, and compares the second chip ID with the first chip ID, the validation verifier determining the credit card is valid when the second chip ID is same as the first chip ID.

6. The on-line credit card payment system of claim 1, wherein the payment application configures display of the mobile terminal to an NFC tagging screen in response to the payment application being automatically operated.

7. A payment method using a mobile terminal comprising:
selecting at least one commodity information transmitted by a shopping mall server accessed by a user terminal, and requesting payment corresponding to the selected commodity information;
receiving a payment signal corresponding to the payment request from the shopping mall server, and generating a push message corresponding to the payment signal;
receiving the push message and operating a payment application automatically in response to receipt of the push message;
extracting information of a credit card in response to tagging the credit card to the mobile terminal;
extracting a card number through a one-time card number (OTC) of the credit card transmitted from the mobile terminal; and
approving credit card payment corresponding to the payment request by using the card number and information in the payment signal.

8. The payment method of claim 7, wherein the payment application configures display of the mobile terminal to a near field communication (NFC) tagging screen in response to the payment application being automatically operated.

9. A payment method using a mobile terminal comprising:
selecting at least one commodity information transmitted by a shopping mall server accessed by a user terminal, and requesting payment corresponding to the selected commodity information;
receiving a payment signal corresponding to the payment request from the shopping mall server, and generating a push message by a payment server corresponding to the payment signal;
tagging the mobile terminal to a credit card storing a block data comprising a chip ID and a first block data;
transmitting the block data to the payment server by receiving the block data of the credit card in response to the tagging, and requesting assignment of a one-time card number (OTC) to the payment server;
requesting payment to a value added network (VAN) company server by adding a purchase item to the OTC;
requesting the block data to the payment server by using the OTC, and extracting a card number of the credit card from the block data, requesting approval of payment by transmitting the card number and the purchase item to a card company server.

10. The payment method of claim 9, wherein step of the requesting assignment of the OTC comprises:
transmitting a first chip ID extracted from the credit card by the mobile terminal to the payment server, and requesting an access key for the credit card;
transmitting the block data extracted from the credit card by the access key to the payment server, and requesting assignment of the OTC.

11. The payment method of claim 10, wherein step of the requesting assignment of the OTC comprises:
extracting a second chip ID by decoding the first chip ID of the block data transferred by the mobile terminal;
verifying validity of the credit card by comparing the first chip ID with the second chip ID.

12. The payment method of claim 9, wherein a payment application configures a display of the mobile terminal to a near field communication (NFC) tagging screen in response to the payment application being automatically operated.

13. A mobile terminal comprising:
a near field communication (NFC) module configured to extract an identification information of a credit card by tagging the credit card to the mobile terminal;
an application driver configured to drive a payment application in response to receiving a push message from a payment server; and
an authentication information processor configured to receive and process authentication information of the credit card by tagging the credit card,
wherein an NFC tagging screen used to tag the credit card is displayed in response to operation of the payment application.

14. The mobile terminal of claim 13, wherein the authentication information processor requests an access key for the credit card by transmitting a first chip ID of the credit card received in response to tagging the credit card.

15. The mobile terminal of claim 14, wherein the authentication information processor extracts block data of the credit card, and transfers the block data and requests a one-time card number (OTC) to the payment server, the authentication information processor transferring payment request information and the OTC received from the payment server to a value added network (VAN) company server.

16. A payment server comprising:
a push message transmitter configured to generate a push message and transmit the push message to a mobile terminal;
an authentication signal generator configured to generate an access key corresponding to block data of a credit card having a first chip ID and a one-time card number (OTC) of the credit card, and transmit the OTC to the mobile terminal; and
a validation verifier configured to verify validation of the credit card with a validation result in response to requesting transmitting of the OTC and the block data transferred from the mobile terminal, and order the authentication signal generator to generate the OTC in response to the validation result.

17. The payment server of claim 16, wherein the validation verifier extracts a second chip ID from a first block data of the block data, and compares the second chip ID with the first chip ID, the validation verifier determining the credit card is valid when the second chip ID is same as the first chip ID.
